(19) United States
(12) Patent Application Publication
(10) Pub. No.: US 2022/0405848 A1
(43) Pub. Date: Dec. 22, 2022

(54) METHOD FOR CREATING AND MAINTAINING A MULTI-ASSET RISK ADVERSE EXPENDITURE TARGETED INFLATION HEDGING INVESTMENT VEHICLE

(71) Applicant: LifeGoal Investments LLC, Saratoga Springs, NY (US)

(72) Inventors: Brett R. Sohns, Saratoga Springs, NY (US); Taylor P. Sohns, Saratoga Springs, NY (US)

(73) Assignee: LifeGoal Investments LLC, Saratoga Springs, NY (US)

(21) Appl. No.: 17/835,306

(22) Filed: Jun. 8, 2022

Related U.S. Application Data
(60) Provisional application No. 63/209,516, filed on Jun. 11, 2021.

(51) Int. Cl. G06Q 40/06; G06Q 40/04

(52) U.S. Cl. CPC G06Q 40/06; G06Q 40/04

(57) ABSTRACT

A method of creating and maintain an investment vehicle by identifying an expenditure target of an investor, determining expenditure target factors, creating an inflationary hedging sleeve including a plurality of equities that have correlate with particular expenditure target factors of the expenditure target, selecting a plurality of groups of securities including equities, fixed income assets, and commodities, determining an asset allocation balance function for investment funding allocation by determining a predetermined portion of subsequent future investment funds to be allocated into each group of securities, selecting an investment vehicle to house the inflationary hedging sleeve plurality of equities and the selected groups of securities with the asset allocation balance function, and naming the selected investment vehicle based on a description of the expenditure target.

### CROSS-REFERENCE TO RELATED APPLICATIONS

This application claims the benefit of U.S. Provisional Patent Application Ser. No. 63/209,516 filed Jun. 11, 2021. The disclosure of the application listed above is incorporated herein by reference in its entirety.

Embodiments presented in this disclosure are directed toward both a method of creating and a method of maintaining a multi-asset risk adverse expenditure targeted inflation hedging investment vehicle.

### BACKGROUND

At the time of filing of this application, inflation in America is around 8.5%. Savings accounts yield nearly 0% in America. Many people plan to save for larger priced expenditures, like a larger vehicle or home, children's college tuition or vacations, as their family grows. It is difficult for most people planning to save for these expenditures since each expenditure requires a different period of time to accumulate the funds required for the expenditure. Therefore, it is difficult to determine a return on an investment for any of these targeted expenditures particularly given the nature of increasing inflation. For example, if someone's savings period is for three years, the purchasing power of the accumulated savings, due to inflation, will be diminished by roughly ten percent during the three-year accumulation period.

Consumers face this persistent challenge with asset price inflation on big-ticket items or big-ticket categories such as, homes, education, weddings, vehicles, children, as well has businesses in planning for business capital expenditures in real estate, manufacturing build-out or acquisitions.

To further illustrate, over the last 50 years, home prices have increased at 5-percent per year. The average consumer saves for 6 years to gather the capital needed for a 20-percent down payment for a home expenditure. The 5-percent year compounded over that average 6-year period is 34-percent. Thus, the home investor actually needs to accrue more than the 20-percent of the target expenditure home price to offset the average 5-percent increase the house expenditure will experience over the 6-year saving accumulation period. Using the average increase in expenditure cost and accumulation period, an individual will need to save approximately 26.8-percent of the current price to equate to the future 20% down payment of the inflation-adjusted home price 6-years from now.

Previous methods and current methods to address saving and investing are savings accounts, CDs from banks, money markets, mutual funds, and a financial advisor managed accounts. In the case of a retail banker selling a CD or other banking product, the banker earns a commission or compensation from their employer is some fashion and these costs are passed on to the saver/investor as lowering net returns.

Financial advisors typically charge 1.0 to 1.5-percent per year depending on asset levels, lower asset levels have higher fees. If the investment objective commands a low risk profile, (which is likely in most cases), the advisor fee becomes a meaningful percentage of the gross return and thereby causing a significant financial drag to the investor's net return. For an example, if the investment is a relatively low risk investment having returns 4-percent per year, and the advisor charges 1.5-percent per year, the advisor is taking 37.5-percent of the return per year.

Furthermore, traditionally investment companies do not name their investment products for any specific item or expenditure the investment product is intended to be used for. Previous and existing financial product names are opaque as to their purpose and cause confusion with investors thereby requiring the use of financial advisors, retail bankers, or the like, that consistently reduce the investor's net gain of the investment by management fees.

None of these methods and vehicles included a specific inflation hedging sleeve. None of these methods and vehicles are designed with the typical savings period factored into the investment time horizon that dictates the appropriate risk profile. For example, the average savings period for a home expenditure is just over 6-years, whereas the average savings period for a vacation is under 1-year. The asset allocation of an investment vehicle used to save for these target expenditures therefore needs to be different.

There exists a need to understand what securities would effectively hedge the item/expenditure the investor is intending to save for and purchase in the future. One would need to understand how to incorporate this into a broader portfolio to help control the inflationary risk of the strategy, while at the same time determine how to offset home price increases. For example, if building material stocks/equities go down by 15-percent, the investor would not want to take that 15-percent hit on their investment vehicle. Therefore, the any potential downturn must be buffered with additional assets that have lower volatility to create a more risk-adverse multi-asset investment vehicle.

Further, there exists a need to manage and rebalance the created investment vehicle during the lifespan of the accumulation period prior to the expenditure target date by considering at least some of the following investment factors:
the rate of inflation on the underlying target good/expenditure;
interest rates on different fixed income instruments;
the direction of broad asset inflation driving the direction of treasury rates;
action by the Federal Reserve its effect on fixed income asset prices;
underlying fundamentals of the individual equities using to as an inflationary hedge toward the specific good/expenditure, (for example, a big-box hardware store's balance sheet strength/weakness affecting the price of the stock and therefore the ability of the corresponding equity to help offset home price inflation);
an equity's correlation with the underlying good/expenditure as an inflationary hedge;
determine how fixed income utilization in the portfolio of the investment vehicle correlates with corresponding hedging equities, (for example, if they begin to correlate too closely, this will cause volatility to pick up);
currency valuations for non-USD bonds;
changes in the liquidity profile of the investment vehicle; and/or changes in tax law effecting the investor's position in the investment vehicle.

There exists a need for the creation of a financial vehicle that can accommodate consumer's future targeted expenditure that take into consideration the cost of inflation and the time required to accumulate the funds sufficient to the future targeted expenditure.

### BRIEF SUMMARY

It should be appreciated that this Summary is provided to introduce a selection of concepts in a simplified form that are further described below in the Detailed Description. This Summary is not intended to be used to limit the scope of the claimed subject matter.

In one embodiment disclosed herein, a method of creating an investment vehicle includes identifying an expenditure target of an investor; determining, for the identified expenditure target, expenditure target factors including an expenditure target price of the identified expenditure target, a market segment type of the identified expenditure target, an average savings duration for the identified expenditure target, an average saving amount for the identified expenditure target, an average tax situation regarding tax consequences for the investor of the identified expenditure target, an average investment price change volatility for the identified expenditure target price, and a price inflation value of the identified expenditure target.

The method above further includes creating, based on the expenditure target and the corresponding expenditure target factors, an inflationary hedging sleeve including a plurality of equities that have a high price inflation correlation with the price inflation value of the identified expenditure target, a high market segment correlation with the market segment type of the expenditure target, and a high price change volatility correlation with the average investment price change volatility for the identified expenditure target.

The method above further includes selecting, based on the identified expenditure target and the price inflation value of the identified expenditure target, a plurality of groups of securities, wherein the groups of securities include equities, fixed income assets, and commodities, and determining an asset allocation balance function, based on the average investment price change volatility for the identified expenditure target, for investment funding allocation, the asset allocation balance function determining a predetermined portion of subsequent future investment funds to be allocated into each of the inflationary hedging sleeve plurality of equities, and each of the selected groups of securities.

The method above further includes selecting an investment vehicle to house the inflationary hedging sleeve plurality of equities and each of the selected groups of securities with the asset allocation balance function, naming the selected investment vehicle based on a description of the expenditure target, and finally listing the named investment vehicle on an exchange configured to allow investors to identify the named investment vehicle, and purchase shares within the named investment vehicle.

In another embodiment disclosed herein, a method of maintaining an investment vehicle including an inflationary hedging sleeve plurality of equities and a plurality of a groups of securities with a risk-based asset allocation balance function includes determining a correlation target discrepancy based on at least one of a high price inflation correlation with a price inflation value of an identified expenditure target of the investment vehicle, a high market segment correlation with a market segment type of the expenditure target of the investment vehicle, and a high price change volatility correlation with an average investment price change volatility for the identified expenditure target of the investment vehicle.

The above method further includes modifying, based on determining the correlation target discrepancy, the investment vehicle by one of selling at least one security from the investment vehicle and reinvesting proceeds of the sale of the at least one security to one of an existing security in the investment vehicle or a new security added to the investment vehicle, or buying at least one security to add to the investment vehicle.

The above method further includes rebalancing, based on determining the correlation target discrepancy, an asset allocation balance function for positions held within the investment vehicle and future investment funds to be allocated to the investment vehicle.

In another embodiment disclosed herein, a non-transitory computer readable media having computer-readable instructions stored thereon which are configured to cause a processor to execute the computer-readable instructions to perform a method of creating an investment vehicle includes identifying an expenditure target of an investor and determining, for the identified expenditure target, expenditure target factors including an expenditure target price of the identified expenditure target, a market segment type of the identified expenditure target, an average savings duration for the identified expenditure target, an average saving amount for the identified expenditure target, an average tax situation regarding tax consequences for the investor of the identified expenditure target, an average investment price change volatility for the identified expenditure target price, and a price inflation value of the identified expenditure target.

non-transitory computer readable media having computer-readable instructions stored thereon which are configured to cause a processor to execute the computer-readable instructions to perform a method of creating, based on the expenditure target and the corresponding expenditure target factors, an inflationary hedging sleeve including a plurality of equities that have a high price inflation correlation with the price inflation value of the identified expenditure target, a high market segment correlation with the market segment type of the expenditure target, and a high price change volatility correlation with the average investment price change volatility for the identified expenditure target.

The non-transitory computer readable media having computer-readable instructions stored thereon which are configured to cause a processor to execute the computer-readable instructions to perform a method of selecting, based on the identified expenditure target and the price inflation value of the identified expenditure target, a plurality of groups of securities, wherein the groups of securities include equities, fixed income assets, and commodities;

The non-transitory computer readable media having computer-readable instructions stored thereon which are configured to cause a processor to execute the computer-readable instructions to perform a method of determining an asset allocation balance function, based on the average investment price change volatility for the identified expenditure target, for investment funding allocation, the asset allocation balance function determining a predetermined portion of subsequent future investment funds to be allocated into each of the inflationary hedging sleeve plurality of equities, and each of the selected groups of securities, and selecting an investment vehicle to house the inflationary hedging sleeve plurality of equities and each of the selected groups of securities with the asset allocation balance function.

### BRIEF DESCRIPTION OF THE SEVERAL VIEWS OF THE DRAWINGS

The embodiments will be better understood from the following detailed description with reference to the drawings, which are not necessarily drawing to scale and in which:

FIG. 1 illustrates a spreadsheet representing an investment portfolio directed toward an expenditure target of an investor for expenses related to a down payment for a home purchase;

FIG. 2 illustrates a spreadsheet representing an investment portfolio directed toward an expenditure target of an investor for child-related expenses;

FIG. 3 illustrates a spreadsheet representing an investment portfolio directed toward an expenditure target of an investor for a vacation expenses;

FIG. 4 illustrates a logic flow diagram of one embodiment of a method of creating an investment vehicle;

FIG. 5 illustrates a continuation of the logic flow diagram of FIG. 4 of the method of creating the investment vehicle;

FIG. 6 illustrates a logic flow diagram of another embodiment of a method of maintaining an investment vehicle; and

FIG. 7 illustrates a logic flow diagram of a computer system configured to enable a method of creating an investment vehicle.

### DETAILED DESCRIPTION

The purpose of the embodiments disclosed herein is to provide an investment vehicle for consumers and businesses to successfully accumulate funds therein, or invest, with the purpose of future expenditures for big-ticket items or categories, for example, homes, education, weddings, vehicles, children, business capital expenditures, or business acquisitions.

One embodiment for contemplating this investment vehicle is an ETF (Exchange Traded Fund) vehicle. Alternative embodiments for contemplating this investment vehicle may be a separately managed account, a mutual fund, an exchange traded note, or a unit investment trust.

One embodiment for contemplating this investment vehicle may be single CUSIP investment, (Committee on Uniform Securities Identification Procedures—where a CUSIP number identifies most financial instruments, including stocks of all registered U.S. and Canadian companies, commercial paper, and U.S. government and municipal bonds), in the form of an ETF designed to create a tolerable return pattern that will help the investor offset the price of inflation of the intended expenditure target.

In another embodiment, where an EFT may not be the appropriate vehicle to use, suppose a manufacturing firm plans to build a large factory five years from now, and they have allocated $2B in cash for the construction project. Rather than use an ETF vehicle better designed for individual investors, the created investment vehicle may be implemented as a separately managed account. Considering the size of the investment, ($2B), there may be enough capital to customize and properly diversify an investment vehicle as a portfolio precisely tailored for the manufacturing firm's construction project. The creation of the underlying investments should increase the likelihood of success for the manufacture's allocated assets to compensate for inflation over the accumulation period. The factors in choosing an appropriate investment vehicle in this scenarios would be differences in materials and costs for a computer factory for a business-oriented expenditure as compared to residential house for a consumer-oriented expenditure. For example, because of these exemplary differences, and the $2B of investable assets, an SMA (Separately Managed Account), likely makes better sense than an ETF.

The disclosed investment vehicle, whether in an EFT investment vehicle, an SMA or any other appropriate investment vehicle, includes an inflation hedging sleeve specifically directed toward the expenditure target. Hedging securities, (for example, stocks (equities), and other investment vehicles), for building a house may be directed to lumber companies, home builders, appliance companies, and commodities related to home building materials.

As home prices continue to rise, stock market performance history has shown a diversified basket of related securities with a high correlation to home prices tend to more than keep pace with the inflation rate of home prices.

The embodiments disclosed herein solve the inflation and saving challenges associated with investors expenditure of big-ticket items and categories.

Another aspect of the embodiment disclosed herein of the investment vehicle is its naming convention of the investment vehicle. The name of the disclosed investment vehicle is chosen to be straight forward and designed to be recognized by investors that may not have any financial background. The naming convention allows for all types of investors to understand the purpose and intention of the disclosed specific investment vehicle such that investors who do not use a financial advisor can still utilize the product and invest in confidence in knowing the purpose and intended outcome of their investment. As financial advisors typically charge an annual percentage fee on assets under management, this advisor management fee often has a direct negative impact on the end investor's total return. The naming convention conveys clear purpose and intention of the disclosed investment vehicle to enable investors to choose and use the investment vehicle free from financial advisor oversight and corresponding management fees, thereby improving the investor's return.

Removing the financial advisor from the investment equation helps the investor reach their goals faster and with a greater likelihood of success. Generally, advisors charge a flat administrative fee, (for example, 1-percent). This fee often becomes a significant financial burden against the advisor-managed portfolios that result in lower returns. For example, if a financial advisor charging a 1-percent management fee on a portfolio with a return target of 3-percent per year, the advisor is keeping 33.3-percent of the investor's gross return.

Given the above-identified factors that have the ability to drive changes in the investment vehicle, (the rate of inflation on the underlying target good/expenditure; interest rates on different fixed income instruments; the direction of broad asset inflation driving the direction of treasury rates; action by the Federal Reserve its effect on fixed income asset prices; underlying fundamentals of the individual equities using to as an inflationary hedge toward the specific good/expenditure; an equity's correlation with the underlying good/expenditure as an inflationary hedge; how fixed income utilization in the portfolio of the investment vehicle correlates with corresponding hedging equities, (for example, if they begin to correlate too closely, this will cause volatility to pick up); currency valuations for non-USD bonds; changes in the liquidity profile of the investment vehicle; and/or changes in tax law effecting the investor's position in the investment vehicle), one of the embodiments disclosed herein contemplate the investment vehicle incorporated within an ETF vehicle. The ETF vehicle allows financial gain turnover to happen within the EFT vehicle without creating a capital gain for investors, unlike a traditional mutual fund. Increasing the tax efficiency allows the investor to get to their goal quicker and with greater chance of success. One of the unique aspects of ETFs is that they trade like stocks in the secondary market. Closed-end funds also trade this way, but the revolutionary thing about the ETF is that it gets special exemptive relief from the SEC (Securities and Exchange Commission) to allow for large institutional investors called Authorized Participants (APs) to create and redeem new shares directly with the fund in exchange for baskets of the underlying portfolio securities. This primary market activity allows for an arbitrage mechanism to force secondary market pricing to be in line with the fund's net asset value. A standard knock on closed-end funds is that there is no arbitrage, so you can experience large premiums and discounts in market pricing relative to the fund's net asset value. ETFs address this concern with the creation/redemption mechanism.

One embodiment of a method creating a multi-asset risk adverse expenditure targeted inflation hedging investment vehicle is to first identify the expenditure target. This expenditure target may be a personal investor's single expenditure like a home, a transportation vehicle, a vacation, or a wedding, or may be a series of expenditures over a period of time like a child's education. Likewise, the expenditure target may be a business investor's single capital expenditure like a manufacturing facility, real estate, or a business acquisition, or may be a series of expenditures over a period of time like anticipated litigation or merger expenses.

The next step in the method of the embodiment includes observing and surveying any socio-economic activity or event to determine the expenditure target factors, for example: a market segment type of the identified expenditure target; an average savings duration for the identified expenditure target; an average saving amount for the identified expenditure target; an average tax situation of an investor for the identified expenditure target; an average investment price volatility of change for the identified expenditure target; a price inflation value of the identified expenditure target, and understand any other personal factors of the typical investor of the intended expenditure target. Many aspects societal culture may be included in the process and are subject to observing and surveying.

The next step in the method of the embodiment includes creating an inflationary hedging sleeve of securities/equities by screening the capital markets investment universe for investable securities/equities that have a high price inflation correlation with the price inflation value of the identified expenditure target, and a strong market segment correlation with the market segment type of the expenditure target. This may include identifying and selecting appropriate securities/equities based on the market segment of the identified expenditure target for inclusion into the inflationary hedging sleeve of securities/equities.

After the inflationary hedging sleeve of equities is created, it may need to be updated consistently for the duration of the investment vehicle after its creation, as the securities markets are in the constant state of change. The following list of examples, as well as similar factors, may cause changes that need to be addressed by rebalancing or restructuring the inflationary hedging sleeve portfolio: global economic changes; cultural change; environmental changes; weather; floods; oil spills; energy commodity issues; technology; politics; and even a change in a general rate of change.

The next step in the method of the embodiment, and after the creation of the inflationary hedging sleeve of equities, includes analyze the list of high price inflation correlating securities, and remove any securities that do not correlate with the market segment of the expenditure target and the overall investment objective. It is likely the high price inflation correlation screening process will identify securities with high price inflation correlation to the expenditure target that may not make the inflationary hedging sleeve of equities. This includes removing securities/equities that show a high price inflation correlation but are in the wrong current market segment of the expenditure target. The removable securities/equities may trigger the wrong current market segment scrutiny as a result of, for example, a name change, a merger/acquisition, technology advances in a disparate field, or a lack of advances thereof, or a dead-end sector, etc.

The following example is of a High Price Inflation Correlation Securities List including good and bad securities for an exemplary expenditure target.

Target Expenditure Item: Residential Home Purchase

List of Securities with a High Correlation to Housing Price Inflation:

| | | |
|---|---|---|
| 1. | Home Builder ABC | Price Inflation Correlation 97-percent |
| 2. | Home Builder XYZ | Price Inflation Correlation 97-percent |
| 3. | Red Eye Biotech Company | Price Inflation Correlation 97-percent |

However, upon review of certain data pertaining to item 3, Red Eye Biotech Company, that company made an acquisition of a smaller competitor at the same time as mortgage rates dramatically fell, causing a housing rising to rise at the same time as the Red Eye Biotech stock price. A further data item indicated that the COVID-19 pandemic created an exodus from cities into suburbia driving up housing costs at roughly the same time Red Eye Biotech Company received FDA approval on a new medical product. The stock price moved up steadily along with the prices of housing costs in America.

Thus, the security Red Eye Biotech does should be removed from the inflationary hedging sleeve of equities as its price inflation correlation caused a high correlation only for a specific period of time for items that were not in the same market segment as the target expenditure and the other equities in the target expenditure market segment having a high correlation with the target expenditure.

When large amounts of data are screened, there may be data points that appear to fulfill the price inflation correlation criteria but may be ironic or bad data. The data point, like Red Eye Biotech Company in the above example, needs to be removed from consideration of the inflationary hedging sleeve of securities/equities.

In another example, an ordered series of equities based on price inflation correlation with the target expenditure may include:

| | | |
|---|---|---|
| 4. | Lumber Company ABC | Price Inflation Correlation 96-percent |
| 5. | Sheetrock Company ABC | Price Inflation Correlation 96-percent |
| 6. | Home Depot | Price Inflation Correlation 94-percent |
| 7. | Lowe's | Price Inflation Correlation 94-percent |
| 8. | Trex Co Wood Alternative | Price Inflation Correlation 93-percent |
| 9. | Whirlpool Appliances | Price Inflation Correlation 92-percent |
| 10. | Stanley Black & Decker | Price Inflation Correlation 92-percent |
| 11. | Marijuana Real Estate LLC | Price Inflation Correlation 92-percent |

Although item 11, Marijuana Real Estate, may seem like bad data or an ironic data point showing a high correlation, upon further review, it is not. Upon further fundamental review, Marijuana Real Estate changed its name from Timber Real Estate in 2019 hoping for better stock price action with the growth of the Marijuana business. 95-percent of Marijuana Real Estate's revenue still comes from its timber farms business and it is still one of the biggest housing lumber suppliers in America.

Thus, a fundamental review of the equity details may determine certain equities are worthy of inclusion into the inflation hedging sleeve for the target objective when at first blush it may not appear so. For example, Marijuana Real Estate LLC should not be removed from the inflation hedging sleeve list of equities.

The next step in the method of the embodiment includes evaluating the volatility of the securities that show a high price inflation correlation to the average investment price volatility of change for the identified expenditure target.

The list of securities showing a high or strong price volatility correlation to the price volatility of change for the expenditure target. The evaluation process consists of a fundamental analysis into equity's company, management, clients, sector, valuations, research and development. The evaluation may be used to determine which securities/equities showing a high price volatility correlation may make for an optimum long-term investment for the target expenditure inflation hedging strategy, (taking into consideration the average saving duration for the expenditure target). The ideal investment, (likely an equity), is an investment that shows a high long-term volatility correlation with the target expenditure item. The company the equity represents may be growing at a steady high rate, has low debt, a strong balance sheets, good management, a great reputation, embraces ESG (Environmental, Social and Governance), appears to be in a promising economic sector, and trades at a reasonable or low relative price.

The next step in the method of the embodiment includes selecting a multi-asset portfolio and balancing the selected portfolio with a risk profile appropriate for the average savings duration of the typical investor for the identified expenditure target. The average savings duration and the expenditure target price change volatility are key to this aspect of the process. Developing an appropriate risk profile are explained by the two following examples:

Expenditure Target(1)=Home Savings−the average saver saves for 6.5 years to buy their first home.

Expenditure Target(2)=Vacation Savings−the average saver saves for 1 year for a vacation.

The risk profile for a Home Savings (1) is very different than a Vacation Savings (2). The Home Savings (1) should take more risk because the investors typically have a longer savings accumulation period than the Vacation Savings (2) investor, while the investor for Vacation Savings (2) should take less risk due to the shorter savings accumulation period, accordingly.

Knowing the average savings duration allows a Portfolio Manager to develop an appropriate multi-asset portfolio for the risk profile. Based on evaluation of the risk profile, as well as the above referenced factors, one hypothetical output may be:
10-percent stocks;
85-percent bonds; and
5-percent commodities,
   while or another risk profile may be:
30-percent stocks;
65-percent bonds; and
5-percent commodities.
   Selection of a risk profile and balancing/allocating existing funds and future funds depends on the behavior of society, the savings details of the average saver, along with the results of the evaluation based on risk described above.

Details of the behavior of representative “target saver” are continuously tracked so the risk profile may more closely match the changing behavior of current and future investors. Specific social factors that are inputs to this step of developing a multi-asset portfolio include average savings duration, expenditure price, down payment percentage, likely annual income, current tax brackets, current tax law, and social market trends. Social change and economic changes are often connected, for example, at the suburban housing price surge created by the COVID-19 social changes in America in the 2020-2021 period.

The next step in the method of the embodiment includes, depending on the appropriate risk profile, modifying by either dialing up or dialing down, the percentage exposure to securities with a high correlation, (the hedging securities having a higher risk). Consider the following examples:

Example 1: If an investor has a one to two-year time savings duration, it is not appropriate for the investor to have the 40-percent of the investment in stocks/equities related to an expenditure target. Stocks/equities are too likely to be volatile during this savings duration and may cause the investor to lose a substantial amount of savings without enough time for the securities/equities to recover any losses.

If a client has a one to two-year time horizon, it may however be appropriate for the investor to have 10 to 15-percent of those securities/equities invested in stocks, whereas the remainder of the investment, 85 to 90-percent, would be in less volatile securities, like bonds and cash. Of the 10 to 15-percent, the investor may want roughly 66 to 100-percent of an equity position to be related to the expenditure target. 66 to 100-percent of the equity allocation is a meaningful percentage of the total allocation that will directly impact the investor's ability to pace inflation of the investment objective. The remaining equity percentage allocation, 0 to 33-percent, may be needed as a portfolio diversifier and potentially stabilizer.

Example 2—If the investor has a 4 to 6-year time horizon it may not be appropriate for the investor to have the 80-percent of the investment in stocks/equities related to the expenditure target. These stocks/equities may likely be too volatile and could cause the investor to lose a substantial amount of their savings without enough time for the volatile securities/equities to potentially recover their losses.

If a client has a 4 to 6-year time horizon it may be appropriate for the investor to have 20 to 35-percent of those securities invested in stocks/equities, the remainder, 65 to 80-percent, would be in less volatile securities like bonds and cash. Of the 20 to 35-percent, the investor may want roughly 50 to 66-percent of stock position to be in securities related to the investment objective. 50 to 66-percent of the stock allocation is a meaningful percentage of the total allocation that will directly impact the investor's ability to pace inflation of the investment objective. The remaining stock percentage, 33 to 50-percent, will be in other, non-related, equities to bring down correlation and dampen volatility.

One aspect of the embodiments presented herein include a range or ranges on the inflation hedging sleeve. The range on the inflation hedging sleeve can be utilized when inflation related securities/equities valuations get stretched to extreme relative pricing levels, such as for example, Price to Earnings (PE) ratio. Buying stock sectors that are priced at extremely high relative ratios have shown to revert to the mean or go down in price relative to other stock sectors. In this scenario, the Portfolio Manager may target the lower end of the inflation hedging securities range and wait for prices to normalize before increasing exposure to the top the range. The same strategy is available when securities show low relative pricing ratios relative to the appropriate sector, such that investors can target the high end of the investment range and then reduce once the target stocks get to average relative price ratios. This flexibility is designed to allow the Portfolio Manager to create a tolerable investor experience with greater odds of investor retention, leading to greater odds of investment objective success.

A further reason for a range or ranges on the inflation hedging sleeve include, depending on the investment objective, the related inflation hedging securities may have a different volatility profile. Stocks in economically cyclical sectors will show greater volatility than stocks in sectors that are less economically sensitive. For example, compare a home building stock or a steel mining company relative to a food/grocery company or healthcare company. The first two examples tend to be more volatile and the inflation hedging sleeve percentage range allows for this to be factored into the broader portfolio risk profile.

The next step in the method of the embodiment includes monitoring the inflation hedging sleeve of securities/equities on an ongoing basis to ensure the price inflation, market segment and price volatility correlations to the expenditure target continue to persist. If certain securities no longer show a meaningful correlation based on one or any of the previous correlation factors, the equities should be removed from the inflation hedging sleeve, and potentially replaced with a new stock/equity, or the reinvested cash allocation should be added to current assets/equities already contained within the inflation hedging sleeve. Monitoring the investment universe may also discover new securities that may be considered to add to the inflation hedging sleeve.

The next step in the method of the embodiment includes monitoring the broader portfolio containing the groups of diversified securities, and steadily rebalancing them as needed to maintain the intended risk profile for the expenditure target based on an exemplary list of items that drive the securities market: direction of Broad Inflation; direction of Broad Growth (GDP); actions the Federal Reserve is currently taking the expectation of future actions; opportunity cost of owning other asset classes; supply and demand dynamics; current security prices in comparison with their historic norms; strength(s) and/or weakness(es) of the larger economy; currency valuations pairings; changes in the liquidity profile; changes in tax law; social change; environmental change; weather events; global conflicts; global shipping and supply chain factors; space travel; etc.

The next step in the method of the embodiment includes monitoring how the inflation hedging securities are correlating with the broader portfolio mentioned above. Generally, the correlation between two different investments within the portfolio will have relatively low correlation, but there are times when the correlation will spike. If and/or when correlation between the two different investments within the portfolio increase, this will cause the overall volatility of the product to increase; this is not a good thing and will need to be constantly monitored.

The next step in the method of the embodiment includes selecting the investment vehicle, i.e., the investment vehicle type, that will house the inflationary hedging sleeve plurality of equities and each of the selected groups of securities. An investment vehicle may be the wrapper, or a lack thereof, that houses the individual investments/instruments that together combine to create a complete investment portfolio. The decision on selecting which investment vehicles to use often depends on tax laws, total portfolio value, security liquidity, Securities and Exchange Commissions (SEC) laws, and other securities market regulations, nuances and costs. In one embodiment, the investment vehicle will be an ETF because of the potential tax benefits the ETF vehicle provides and the trade efficiencies of reinvesting funds.

Under many circumstances the ETF type vehicle may generate the best results for the widest range of investors. However, there are circumstances where a mutual fund, separately managed account (SMA), exchange traded note, unit investment trust, or a newly invented vehicle may be a more appropriate investment. The invention process will help drive the investment vehicle decision making process.

When an EFT investment vehicle type is selected, day-to-day supervision of operations of the funds is directed to daily construction and maintenance of EFT creation/redemption baskets of the underlying portfolio securities. A fund administrator may then act as a liaison with the National Securities Clearing Corporation (NSCC) to disseminate the daily basket files to APs (Authorized Participants), market makers and other capital markets participants.

An EFT is selected to be listed on a particular exchange to be traded, as well as the selection of APs and other market makers to help provide liquidity. An indicative intraday NAV (Net Asset Value) IIV (Intraday Indicative Value) agent may be selected that may be a requirement of the exemptive orders to provide updated pricing estimates for the fund's NAV at least every 15 seconds throughout the trading day.

An ETF's NAV, like the NAV for a mutual fund, is its per share value based on the closing prices of its underlying securities. An ETF's NAV is calculated daily, using the same standard formula used for valuing mutual fund shares, i.e., asset value less liabilities, over the number of outstanding shares.

Intraday Indicative Value (IIV) The intraday value is a real-time estimate of an ETF's fair value, based on the most recent prices of its underlying securities. Because intraday values are generally published by the exchanges every 15 seconds, they should closely approximate the value of an ETF's holdings. Investors should not expect to buy or sell an ETF at its intraday value. This value simply helps investors gauge if an ETF's current market price is in line with the value of the ETF's holdings, or if it's trading at a discount or premium.

Additionally, a publicly available website with certain key information about the created ETF may also be provided.

The embodiments presented herein are directed to a specific inflation hedging investment sleeve, where when an investor is saving for an expenditure target, like a home purchase down payment, a portfolio manager invests in securities that have shown a high correlation with the price inflation of homes. The inflation hedging sleeve of the portfolio is specifically designed to help offset the price inflation of the specific expenditure target of the investor. This inflation hedging sleeve may be invested in securities/equities that show a high correlation with the inflation of the specific expenditure target over the savings accumulation period.

The embodiments presented herein are directed to a creating a multi-asset portfolio with a risk profile appropriate for a stated expenditure target. The risk profile is designed based on the typical time the investor/saver needs to reach their savings target value as well as other specific social savings details.

The embodiments presented herein are directed to an investment vehicle naming convention that clearly identifies to intended expenditure target. For example, an investment vehicle “Home Savings Fund,” is for housing, an investment vehicle “Children Savings Fund,” is for costs associated with raising and educating children. This naming convention removes the need for any financial advisor fees from the net investment return that adversely shortens the savings time needed and increases the chance of success toward the expenditure target.

The embodiments presented herein are directed to choosing an investment vehicle to house the investment portfolio. The ETF vehicle may be well suited for many investors due to the potential tax benefits that minimize the tax consequence of capital gain exposure. However, the embodiments presented herein may be housed inside other non-EFT investment vehicles.

When the ETF is selected as an investment vehicle, the ETF vehicle has the potential to substantially reduce capital gains tax obligations on securities turnover within the ETF. This makes the ETF vehicle a potential tax shield to the investor as the underlying multi-asset portfolio may need to be rebalanced several times a year in order to maintain an appropriate risk profile. For example, if the portfolio is rebalanced twice a year, then over a six-year total investment period, the portfolio will have had a total of twelve rebalances. Portfolio rebalances typically consist of trimming the strong performing securities and adding the gains to the underperforming securities to keep the appropriate balance or desired asset mix. Each time a security is sold at a gain, there is the potential for capital gains taxes—a negative to the net proceeds of the investor. There are special characteristics of the ETF that allow a reduction or complete elimination of these taxable capital gain events. Paying short or long-term capital gains taxes multiple times a year for many years may add up to a meaningful reduction of the total net return. Using an ETF as an investment vehicle protects the investor from this type of capital gain “tax drag” over the course of the rebalancing process.

Furthermore, when the ETF is selected as an investment vehicle, the ETF vehicle is also free to buy or sell at most brokers, has no minimum holding period, and has no minimum investment amount. ETFs also tend to have lower expenses for the investor putting a greater portion of net returns in the investor's pocket.

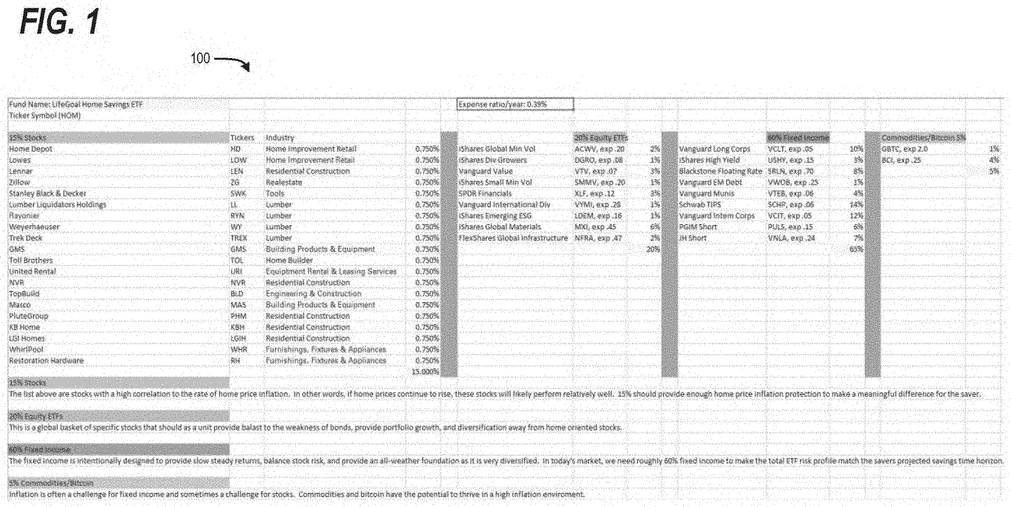

Example Product Details of FIG. 1 and the spreadsheet 100:

Name: “Lifegoal Home Savings EFT”—Ticker symbol, “HOM”

Vehicle Type: ETF

Allocation Balance:
Individual stocks/equities: 15-percent;
3rd party stock ETFs: 20-percent;
3rd party fixed income ETFs 60-percent;
Diversified commodities ETF, 4-percent; and
Bitcoin, 1-percent.

The 15-percent of individual stocks/equities is a diversified list of stocks/equities that show a high correlation to the price inflation within the housing market expenditure target category by diversifying the selection of high correlation equities within the broad housing industry sector to manage risk.

The 20-percent stocks ETF brings the total HOM ETF allocation to 35% stocks/equities to provide a meaningful contribution to long term performance of the investment. The 20% equity ETF sleeve also tends to have a low correlation with fixed income returns, this is important in the future when balancing the total risk of the HOM ETF over the duration of the investment.

The 60-percent fixed income ETFs are selected for their potential risk adjusted return profile in providing targeting slow and steady returns. The ETFs included also tend to have a low relative correlation to each other, hopefully creating an all-weather fixed income foundation for the HOM ETF.

The 4-percent commodities and 1-percent Bitcoin are included to perform well during periods of high general inflation. General inflation can very negatively impact the return of fixed income, potentially dampen or rattle stock returns. General inflation is generally a very good thing for the returns of commodities and bitcoin, and as a result, differentiated returns pattern commodities and Bitcoin can help the HOM saver achieve their goals.

When economic, tax, political, social or environmental characteristics change, the above investment portfolio housed within the ETF investment vehicle will likely need to be adjusted over its intended accumulation period to meet the future goals of the target HOM investor.

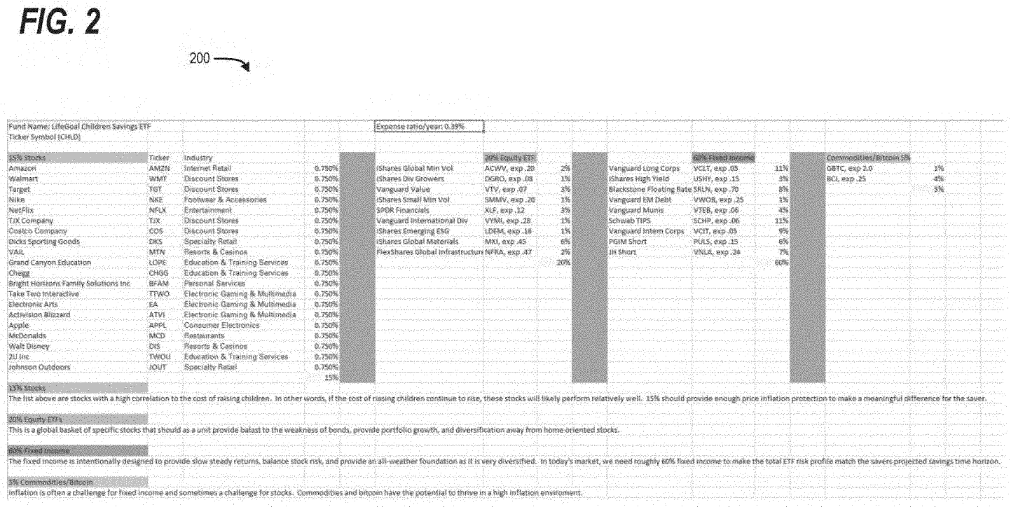

Similarly, FIG. 2 illustrates a targeted investment portfolio, “CHLD,” in spreadsheet 200, as a children related expenditure target investment vehicle.

Example Product Details of FIG. 2 and the spreadsheet 200:

Name: “BRANDNAME Children Savings”—Ticker symbol, “CHLD”

Vehicle Type: ETF

Allocation Balance:
Individual stocks/equities: 15-percent;
3rd party stock ETFs: 20-percent;
3rd party fixed income ETFs 60-percent;
Diversified commodities ETF, 1-percent; and
Bitcoin, 4-percent.

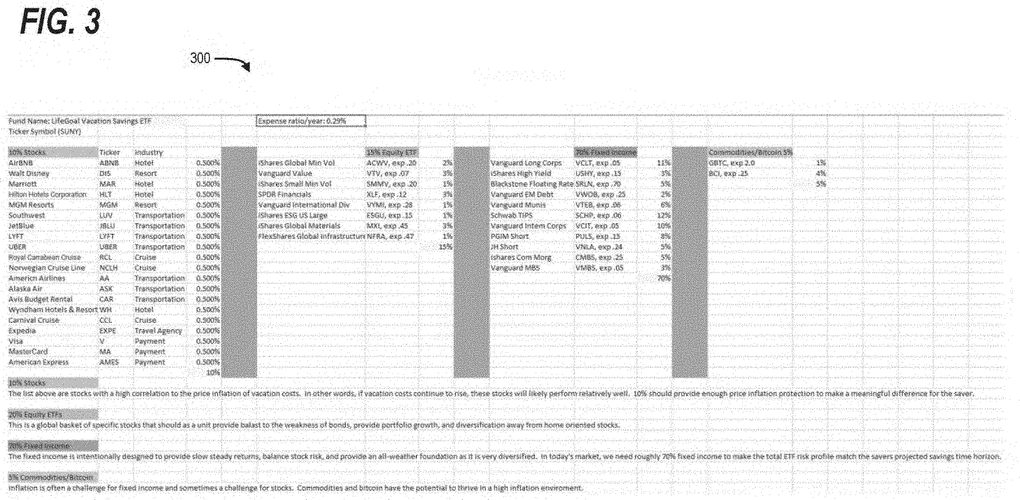

Similarly, FIG. 3 illustrates a targeted investment portfolio, “SUNY,” in spreadsheet 300, as a vacation related expenditure target investment vehicle.

Example Product Details of FIG. 3 and the spreadsheet 300:

Name: “BRANDNAME Vacation Savings”—Ticker symbol, “SUNY”

Vehicle Type: ETF

Allocation Balance:
Individual stocks/equities: 10-percent;
3rd party stock ETFs: 15-percent;
3rd party fixed income ETFs 70-percent;
Diversified commodities ETF, 1-percent; and
Bitcoin, 4-percent.

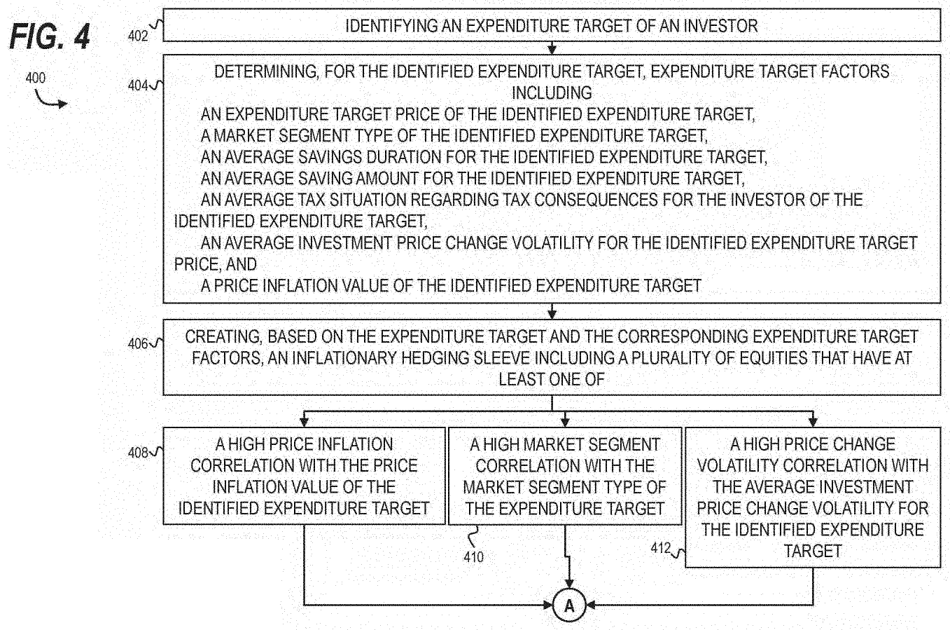

FIG. 4 illustrates a logic flow diagram 400 of a method of creating an investment vehicle where the method includes identifying 402 an expenditure target of an investor and then determining 404, for the identified expenditure target, expenditure target factors including: an expenditure target price of the identified expenditure target; a market segment type of the identified expenditure target; an average savings duration for the identified expenditure target; an average saving amount for the identified expenditure target; an average tax situation regarding tax consequences for the investor of the identified expenditure target; an average investment price change volatility for the identified expenditure target price; and a price inflation value of the identified expenditure target.

The method further includes creating 406, based on the expenditure target and the corresponding expenditure target factors, an inflationary hedging sleeve including a plurality of equities that have at least one of 1) a high price inflation correlation 408 with the price inflation value of the identified expenditure target, 2) a high market segment correlation 410 with the market segment type of the expenditure target, and 3) a high price change volatility correlation 412 with the average investment price change volatility for the identified expenditure target.

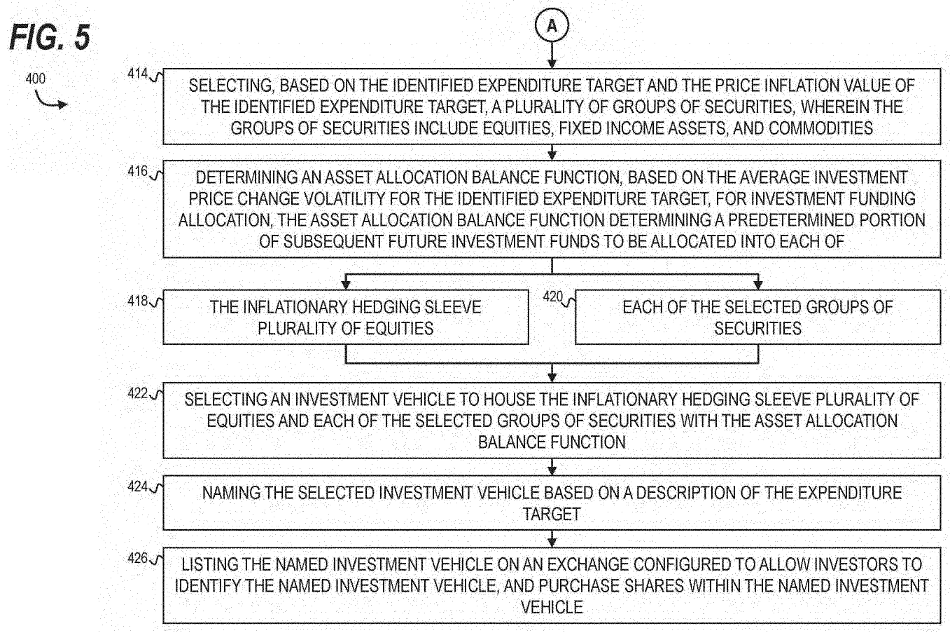

The method further includes, as illustrated in FIG. 5 following from (A) in FIG. 4, selecting 414, based on the identified expenditure target and the price inflation value of the identified expenditure target, a plurality of groups of securities, wherein the groups of securities include equities, fixed income assets, and commodities.

The method further includes determining 416 an asset allocation balance function, based on the average investment price change volatility for the identified expenditure target, for investment funding allocation, the asset allocation balance function determining a predetermined portion of subsequent future investment funds to be allocated into each of the inflationary hedging sleeve plurality of equities 418, and each of the selected groups of securities 420.

The method further includes selecting 422 an investment vehicle to house the inflationary hedging sleeve plurality of equities and each of the selected groups of securities with the asset allocation balance function, naming 424 the selected investment vehicle based on a description of the expenditure target, and finally, listing 426 the named investment vehicle on an exchange configured to allow investors to identify the named investment vehicle, and purchase shares within the named investment vehicle.

The above embodiment contemplates wherein the expenditure target includes an independent investor's expenditure target.

The above embodiment contemplates wherein the expenditure target includes one from the group of: expenses related to purchasing a home; expenses related to vacation; expenses related to purchasing a transportation vehicle; expenses related to a wedding; expenses related to a child's education or medical care.

The above embodiment contemplates wherein the expenditure target includes a business inventor's expenditure target.

The above embodiment contemplates wherein the expenditure target includes one from the group of: a capital investment project; a business acquisition; and a capital expense.

The above embodiment contemplates wherein the groups of securities include further include at least one mutual fund.

The above embodiment contemplates wherein selecting the investment vehicle to house the inflationary hedging sleeve plurality of equities and each of the selected groups of securities with the asset allocation balance function includes selecting an Exchange Traded Fund (ETF) as the investment vehicle.

The above embodiment contemplates wherein selecting the investment vehicle to house the inflationary hedging sleeve plurality of equities and each of the selected groups of securities with the asset allocation balance function includes selecting a mutual fund as the investment vehicle.

The above embodiment contemplates wherein selecting the investment vehicle to house the inflationary hedging sleeve plurality of equities and each of the selected groups of securities with the asset allocation balance function includes selecting a Separately Managed Account (SMA) as the investment vehicle.

The above embodiment contemplates wherein selecting the investment vehicle to house the inflationary hedging sleeve plurality of equities and each of the selected groups of securities with the asset allocation balance function includes selecting an exchanged traded note as the investment vehicle.

The above embodiment contemplates wherein selecting the investment vehicle to house the inflationary hedging sleeve plurality of equities and each of the selected groups of securities with the asset allocation balance function includes selecting a unit investment trust as the investment vehicle.

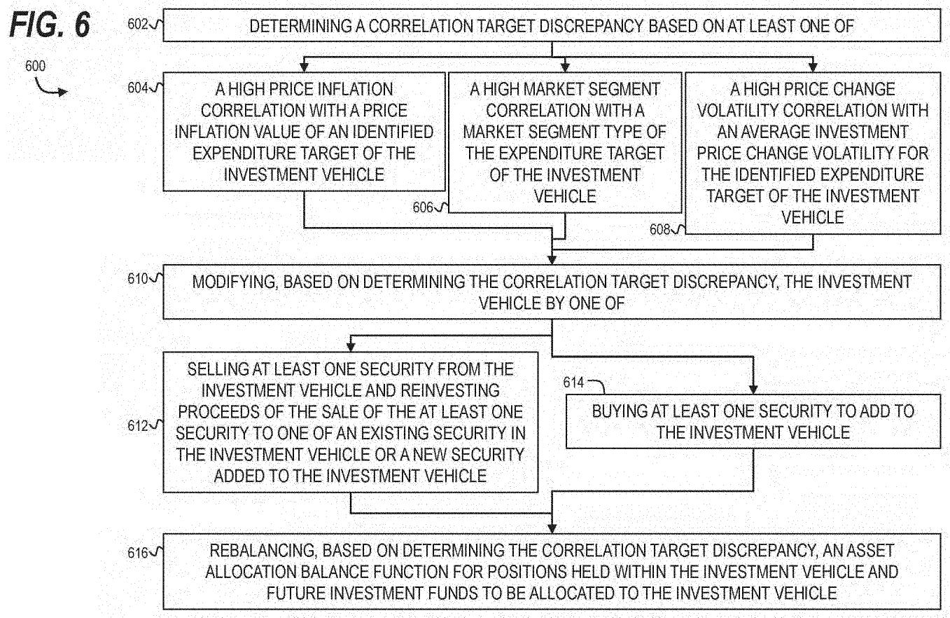

FIG. 6 illustrates a logic diagram 600 of another embodiment presented herein that includes a method of maintaining an investment vehicle including an inflationary hedging sleeve plurality of equities and a plurality of a groups of securities with a risk-based asset allocation balance function, where the method includes determining 602 a correlation target discrepancy based on at least one of 1) a high price inflation correlation 604 with a price inflation value of an identified expenditure target of the investment vehicle, 2) a high market segment correlation 606 with a market segment type of the expenditure target of the investment vehicle, and 3) a high price change volatility correlation 608 with an average investment price change volatility for the identified expenditure target of the investment vehicle.

The method further includes modifying 610, based on determining the correlation target discrepancy, the investment vehicle by one of 1) selling 612 at least one security from the investment vehicle and reinvesting proceeds of the sale of the at least one security to one of an existing security in the investment vehicle or a new security added to the investment vehicle, or 2) buying 614 at least one security to add to the investment vehicle.

The method further includes rebalancing 616, based on determining the correlation target discrepancy, an asset allocation balance function for positions held within the investment vehicle and future investment funds to be allocated to the investment vehicle.

The above embodiment contemplates monitoring general investment factors including at least one from the group of: a direction of Broad Inflation; a direction of Broad Growth (GDP); actions taken by the Federal Reserve; future action anticipated to be taken by the Federal Reserve; opportunity cost of owning other asset classes; national and global supply and demand economic factors; current security prices in comparison with their historic norms; one of strengths and weakness of a national economy; international currency valuation pairings; changes to a national liquidity profile; changes in taxation law; national and global social change; national and global environmental change; national and global weather events; national and global conflicts; national and global shipping and supply chain factors; and space travel.

The above embodiment contemplates wherein modifying the investment vehicle is further based on at least one of the monitored general investment factors.

The above embodiment contemplates wherein rebalancing the asset allocation balance function for positions held within the investment vehicle and future investment funds to be allocated to the investment vehicle is further based on at least one of the monitored general investment factors.

Another embodiment presented herein includes a non-transitory computer readable media having computer-readable instructions stored thereon which are configured to cause a processor to execute the computer-readable instructions to perform a method of creating an investment vehicle, the method including identifying an expenditure target of an investor and determining, for the identified expenditure target, expenditure target factors including: an expenditure target price of the identified expenditure target; a market segment type of the identified expenditure target; an average savings duration for the identified expenditure target; an average saving amount for the identified expenditure target; an average tax situation regarding tax consequences for the investor of the identified expenditure target; an average investment price change volatility for the identified expenditure target price; and a price inflation value of the identified expenditure target.

The method further includes creating, based on the expenditure target and the corresponding expenditure target factors, an inflationary hedging sleeve including a plurality of equities that have 1) a high price inflation correlation with the price inflation value of the identified expenditure target, 2) a high market segment correlation with the market segment type of the expenditure target, and 3) a high price change volatility correlation with the average investment price change volatility for the identified expenditure target.

The method further includes selecting, based on the identified expenditure target and the price inflation value of the identified expenditure target, a plurality of groups of securities, wherein the groups of securities include equities, fixed income assets, and commodities.

The method further includes determining an asset allocation balance function, based on the average investment price change volatility for the identified expenditure target, for investment funding allocation, the asset allocation balance function determining a predetermined portion of subsequent future investment funds to be allocated into each of the inflationary hedging sleeve plurality of equities, and each of the selected groups of securities.

The method further includes selecting an investment vehicle to house the inflationary hedging sleeve plurality of equities and each of the selected groups of securities with the asset allocation balance function.

The above embodiment contemplates wherein selecting the investment vehicle to house the inflationary hedging sleeve plurality of equities and each of the selected groups of securities with the asset allocation balance function includes selecting an Exchange Traded Fund (ETF) as the investment vehicle.

The above embodiment contemplates wherein the expenditure target includes one of: an independent investor's expenditure target from one from the group of: expenses related to purchasing a home; expenses related to vacation; expenses related to purchasing a transportation vehicle; expenses related to a wedding; and expenses related to a child's education or medical care; and a business inventor's expenditure target from one of the group of: a capital investment project; a business acquisition; and a capital expense.

The above embodiment contemplates naming the selected investment vehicle based on a description of the expenditure target; and listing the named investment vehicle on an exchange configured to allow investors to identify the named investment vehicle, and purchase shares within the named investment vehicle.

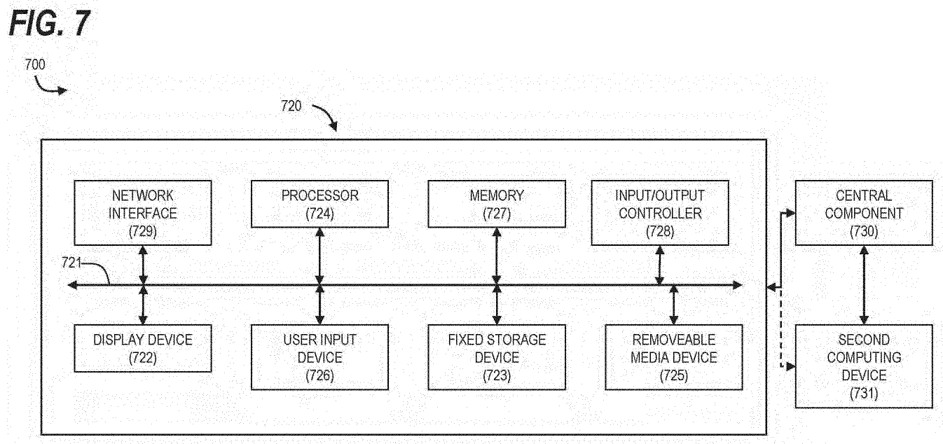

Implementations of the presently disclosed subject matter may be implemented in and used with a variety of component and network architectures. FIG. 7 is an example illustration of a logical representation of a computer network 700 including a computer 720 suitable for implementing implementations of the presently disclosed subject matter. As discussed in further detail herein, the computer 720 may be a single computer in a network of multiple computers. As shown in FIG. 7, computer 720 may communicate with a central component 730 (e.g., server, cloud server, database, etc.). The central component 730 may communicate with one or more other computers such as the second computer 731. According to this implementation, the information obtained to and/or from a central component 730 may be isolated for each computer such that computer 720 may not share information with computer 731. Alternatively, or in addition, computer 720 may communicate directly with the second computer 731.

The computer (e.g., user computer, enterprise computer, etc.) 720 includes a bus 721 which interconnects major components of the computer 720, such as a central processor 724, a memory 727, (typically RAM, but which may also include ROM, flash RAM, or the like), an input/output controller 728, a user display device 722, such as a display or touch screen via a display adapter, a user input interface 726, which may include one or more controllers and associated user input or devices such as a keyboard, mouse, Wi-Fi/cellular radios, touchscreen, microphone/speakers and the like, and may be closely coupled to the I/O controller 728, fixed storage 723, such as a hard drive, flash storage, Fibre Channel network, SAN device, SCSI device, and the like, and a removable media component 725 operative to control and receive an optical disk, flash drive, and the like.

The bus 721 enable data communication between the central processor 724 and the memory 727, which may include read-only memory (ROM) or flash memory (neither shown), and random-access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components.

Applications resident with the computer 720 can be stored on and accessed via a computer readable medium, such as a hard disk drive (e.g., fixed storage 723), an optical drive, floppy disk, solid state memory drives, or other storage medium 725.

The fixed storage 723 may be integral with the computer 720 or may be separate and accessed through other interfaces. A network interface 729 may provide a direct connection to a remote server via a telephone link, to the Internet via an internet service provider (ISP), or a direct connection to a remote server via a direct network link to the Internet via a POP (point of presence) or other technique. The network interface 729 may provide such connection using wireless techniques, including digital cellular telephone connection, Cellular Digital Packet Data (CDPD) connection, digital satellite data connection or the like. For example, the network interface 729 may enable the computer to communicate with other computers via one or more local, wide-area, or other networks.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 727, fixed storage 723, removable media 725, or on a remote storage location.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to generate specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general-purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific arrangements and configurations. However, the illustrative examples provided herein are not intended to be exhaustive or to limit embodiments of the disclosed subject matter to the precise forms disclosed. Many modifications and variations are possible in view of the disclosure provided herein. The embodiments and arrangements were chosen and described in order to explain the principles of embodiments of the disclosed subject matter and their practical applications. Various modifications may be used without departing from the scope or content of the disclosure and claims presented herein.

What is claimed is:

1. A method of creating an investment vehicle, the method comprising:
identifying an expenditure target of an investor;
determining, for the identified expenditure target, expenditure target factors including
an expenditure target price of the identified expenditure target,
a market segment type of the identified expenditure target,
an average savings duration for the identified expenditure target,
an average saving amount for the identified expenditure target,
an average tax situation regarding tax consequences for the investor of the identified expenditure target,
an average investment price change volatility for the identified expenditure target price, and
a price inflation value of the identified expenditure target;
creating, based on the expenditure target and the corresponding expenditure target factors, an inflationary hedging sleeve including a plurality of equities that have
a high price inflation correlation with the price inflation value of the identified expenditure target,
a high market segment correlation with the market segment type of the expenditure target, and
a high price change volatility correlation with the average investment price change volatility for the identified expenditure target;
selecting, based on the identified expenditure target and the price inflation value of the identified expenditure target, a plurality of groups of securities, wherein the groups of securities include equities, fixed income assets, and commodities;
determining an asset allocation balance function, based on the average investment price change volatility for the identified expenditure target, for investment funding allocation, the asset allocation balance function determining a predetermined portion of subsequent future investment funds to be allocated into each of
the inflationary hedging sleeve plurality of equities, and
each of the selected groups of securities;
selecting an investment vehicle to house the inflationary hedging sleeve plurality of equities and each of the selected groups of securities with the asset allocation balance function;
naming the selected investment vehicle based on a description of the expenditure target; and
listing the named investment vehicle on an exchange configured to allow investors to identify the named investment vehicle, and purchase shares within the named investment vehicle.

2. The method of claim 1, wherein the expenditure target includes an independent investor's expenditure target.

3. The method of claim 2, wherein the expenditure target includes one from the group of:
expenses related to purchasing a home;
expenses related to vacation;
expenses related to purchasing a transportation vehicle;
expenses related to a wedding;
expenses related to a child's education or medical care.

4. The method of claim 1, wherein the expenditure target includes a business inventor's expenditure target.

5. The method of claim 4, wherein the expenditure target includes one from the group of:
a capital investment project;
a business acquisition; and
a capital expense.

6. The method of claim 1, wherein the groups of securities include further include at least one mutual fund.

7. The method of claim 1, wherein selecting the investment vehicle to house the inflationary hedging sleeve plurality of equities and each of the selected groups of securities with the asset allocation balance function includes selecting an Exchange Traded Fund (ETF) as the investment vehicle.

8. The method of claim 1, wherein selecting the investment vehicle to house the inflationary hedging sleeve plurality of equities and each of the selected groups of securities with the asset allocation balance function includes selecting a mutual fund as the investment vehicle.

9. The method of claim 1, wherein selecting the investment vehicle to house the inflationary hedging sleeve plurality of equities and each of the selected groups of securities with the asset allocation balance function includes selecting a Separately Managed Account (SMA) as the investment vehicle.

10. The method of claim 1, wherein selecting the investment vehicle to house the inflationary hedging sleeve plurality of equities and each of the selected groups of securities with the asset allocation balance function includes selecting an exchanged traded note as the investment vehicle.

11. The method of claim 1, wherein selecting the investment vehicle to house the inflationary hedging sleeve plurality of equities and each of the selected groups of securities with the asset allocation balance function includes selecting a unit investment trust as the investment vehicle.

12. A method of maintaining an investment vehicle including an inflationary hedging sleeve plurality of equities and a plurality of a groups of securities with a risk-based asset allocation balance function, the method comprising:
determining a correlation target discrepancy based on at least one of
a high price inflation correlation with a price inflation value of an identified expenditure target of the investment vehicle,
a high market segment correlation with a market segment type of the expenditure target of the investment vehicle, and
a high price change volatility correlation with an average investment price change volatility for the identified expenditure target of the investment vehicle;
modifying, based on determining the correlation target discrepancy, the investment vehicle by one of
selling at least one security from the investment vehicle and reinvesting proceeds of the sale of the at least one security to one of an existing security in the investment vehicle or a new security added to the investment vehicle, or
buying at least one security to add to the investment vehicle; and
rebalancing, based on determining the correlation target discrepancy, an asset allocation balance function for positions held within the investment vehicle and future investment funds to be allocated to the investment vehicle.

13. The method of maintaining an investment vehicle of claim 12, further including monitoring general investment factors including at least one from the group of:
a direction of Broad Inflation;
a direction of Broad Growth (GDP);
actions taken by the Federal Reserve;
future action anticipated to be taken by the Federal Reserve;
opportunity cost of owning other asset classes;
national and global supply and demand economic factors;
current security prices in comparison with their historic norms;
one of strengths and weakness of a national economy;
international currency valuation pairings;
changes to a national liquidity profile;
changes in taxation law;
national and global social change;
national and global environmental change;
national and global weather events;
national and global conflicts;
national and global shipping and supply chain factors; and
space travel.

14. The method of maintaining an investment vehicle of claim 13, wherein modifying the investment vehicle is further based on at least one of the monitored general investment factors.

15. The method of maintaining an investment vehicle of claim 13, wherein rebalancing the asset allocation balance function for positions held within the investment vehicle and future investment funds to be allocated to the investment vehicle is further based on at least one of the monitored general investment factors.

16. A non-transitory computer readable media having computer-readable instructions stored thereon which are configured to cause a processor to execute the computer-readable instructions to perform a method of creating an investment vehicle, the method comprising:
identifying an expenditure target of an investor;
determining, for the identified expenditure target, expenditure target factors including
an expenditure target price of the identified expenditure target,
a market segment type of the identified expenditure target,
an average savings duration for the identified expenditure target,
an average saving amount for the identified expenditure target,
an average tax situation regarding tax consequences for the investor of the identified expenditure target,
an average investment price change volatility for the identified expenditure target price, and
a price inflation value of the identified expenditure target;
creating, based on the expenditure target and the corresponding expenditure target factors, an inflationary hedging sleeve including a plurality of equities that have
a high price inflation correlation with the price inflation value of the identified expenditure target,
a high market segment correlation with the market segment type of the expenditure target, and
a high price change volatility correlation with the average investment price change volatility for the identified expenditure target;
selecting, based on the identified expenditure target and the price inflation value of the identified expenditure target, a plurality of groups of securities, wherein the groups of securities include equities, fixed income assets, and commodities;
determining an asset allocation balance function, based on the average investment price change volatility for the identified expenditure target, for investment funding allocation, the asset allocation balance function determining a predetermined portion of subsequent future investment funds to be allocated into each of
the inflationary hedging sleeve plurality of equities, and
each of the selected groups of securities; and
selecting an investment vehicle to house the inflationary hedging sleeve plurality of equities and each of the selected groups of securities with the asset allocation balance function.

17. The non-transitory computer readable media of claim 16, wherein selecting the investment vehicle to house the inflationary hedging sleeve plurality of equities and each of the selected groups of securities with the asset allocation balance function includes selecting an Exchange Traded Fund (ETF) as the investment vehicle.

18. The non-transitory computer readable media of claim 16, wherein the expenditure target includes one of:
an independent investor's expenditure target from one from the group of:
expenses related to purchasing a home;
expenses related to vacation;
expenses related to purchasing a transportation vehicle;
expenses related to a wedding; and
expenses related to a child's education or medical care; and
a business inventor's expenditure target from one of the group of:
a capital investment project;
a business acquisition; and
a capital expense.

19. The non-transitory computer readable media of claim 16, the method further comprising naming the selected investment vehicle based on a description of the expenditure target; and

20. The non-transitory computer readable media of claim 16, the method further comprising listing the named investment vehicle on an exchange configured to allow investors to identify the named investment vehicle, and purchase shares within the named investment vehicle.
